(19) United States
(12) Patent Application Publication
(10) Pub. No.: US 2019/0197043 A1
(43) Pub. Date: Jun. 27, 2019

(54) SYSTEM AND METHOD FOR ANALYSIS AND REPRESENATION OF DATA

(71) Applicant: Marlabs Innovations Private Limited, Bengaluru (IN)

(72) Inventors: Senthil Nathan Rajendran, Bengaluru (IN); Selvarajan Kandasamy, Bengaluru (IN); Tejas Gowda BK, Bengaluru (IN); Mitali Sodhi, Bengaluru (IN); Gulshan Gaurav, Bengaluru (IN)

(21) Appl. No.: 16/033,268

(22) Filed: Jul. 12, 2018

(30) Foreign Application Priority Data
Dec. 27, 2017 (IN) 201741046794

(51) Int. Cl. G06F 16/26; G06F 16/904; G06F 17/18; G06N 5/04

(52) U.S. Cl. CPC G06F 16/26; G06N 5/04; G06F 17/18; G06F 16/904

(57) ABSTRACT

A system and method for analysis and representation of data are provided. The system includes a memory configured to receive a plurality of data sets. The system also includes a processing subsystem operatively coupled to the memory and configured to select one or more numeric variables of the plurality of data sets. The processing subsystem is further configured to analyse the one or more numeric variables of the plurality of data sets based on the plurality of properties of the plurality of data sets, identify one or more custom rules based on the plurality of data sets, identify graphical representation based on outcome of the one or more identified custom rules, identify one or more textual insights based on outcome of the one or more custom rules and represent identified graphical representation and one or more textual insights on a display device.

### CROSS-REFERENCE TO RELATED APPLICATION

This application claims the benefit of Complete Patent Application bearing application no. 201741046794, filed on Dec. 27, 2017 in India.

### BACKGROUND

Embodiments of the present disclosure relate to data analysis and presentation, and more particularly to a system and method for analysis and representation of data.

Statistical methods involved in carrying out a study include planning, designing, collecting data, analysing, drawing meaningful interpretation and reporting of the research findings. The statistical data analysis gives meaning to the meaningless numbers and transforming, and modelling statistical data with the goal of discovering useful information, suggesting conclusions, and supporting decision-making. such data analysis has multiple facets, approaches and encompassing diverse techniques for analysing and predicting the data.

Conventionally, data prediction is done manually using available business data analysis tools. However, such tools displaying data in the form of tables and graphs but the interpretation of these tables and graphs is then left to analyst. However, a long time required for analysis and presentation of insights. Further, extra time is required to present analysis reports by typing word documents and creating presentations. The insight gained from this data can be person-dependent and tool-dependent. Additionally, the typical analyst does not have the skills in statistics and data mining both which lead to wrong prediction results.

In another approach, the system performs analysis for one or more identified questions asked by the user. The analysis is performed based on the set of stored pre-defined data. The system does the analysis based on the provided data analysis engine. Further the system displays the analysed data in the form of an instant text message, a voice message, an e-mail or a web interface. However, in such systems the data set to be analysed is not predicted by the system. Also such system may miss out analysing one or more questions asked by the user.

In yet another approach, the system analysing a plurality of data from the pre-defined set in a computing device. The system automatically identifies the relevant data set which has to be identified from the pre-defined data set. The system also uses natural language to communicate between the user and the system. Further, the system produces one or more insights based on the strength of the data. However, in such system, the analysed data is not presented in a simple format which makes the analysis difficult to understand by the user, hence the user has to further analyse the data accordingly to understand the analysis done by the system.

In yet another approach, the system uses a basic statistical machine learning model to analyse the set of data. The system identifies one or more key elements from a pre-defined text and a pre-defined table of data for further analysis of the data. The identified set of data is further matched with the insights which are in a pre-defined template form and is further presented in the form of the natural language. However, in such approach, the system does not identify the relevant data set automatically. Also, analysis of the data is not done based on the strength of the data set. Further, the presentation of the analysed data is complicated. Also, the system does not provide insights based on a particular variable require.

Hence, there is a need for an improved system and method for data analysis and presentation of data to address the aforementioned issues.

### BRIEF DESCRIPTION

In accordance with one embodiment of the disclosure, a system for analysis and representation of data is provided. The system includes a memory configured to receive a plurality of data sets. The system also includes a processing subsystem operatively coupled to the memory and configured to determine a plurality of properties of the plurality of data sets. The processing subsystem is also configured to select one or more numeric variables of the plurality of data sets. The processing subsystem is further configured to analyse the one or more numeric variables of the plurality of data sets based on the plurality of properties of the plurality of data sets. The processing subsystem is further configured to identify one or more custom rules based on the plurality of data sets. The processing subsystem is further configured to derive one or more interpretations and one or more related output based on one or more identified custom rules. The processing subsystem is further configured to identify graphical representation based on outcome of the one or more identified custom rules. The processing subsystem is further configured to identify one or more textual insights based on outcome of the one or more custom rules. The processing subsystem is further configured to represent identified graphical representation and one or more textual insights on a display device.

In accordance with another embodiment of the disclosure, the method for analysis and representation of data is provided. The method includes receiving a plurality of data sets. The method also includes determining a plurality of properties of data set. The method further includes selecting one or more numeric variables of the plurality of data sets. The method further includes analysing the one or more numeric variables of the plurality of data sets based on the plurality of properties of the plurality of data sets. The method further includes identifying one or more custom rules based on the plurality of data sets. The method further includes deriving one or more interpretations and one or more related output based on one or more identified custom rules. The method further includes identifying graphical representation based on outcome of the one or more identified custom rules. The method further includes identifying one or more textual insights based on outcome of the one or more custom rules. The method further includes representing identified graphical representation and one or more textual insights.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for analysis and representation of data in accordance with an embodiment of the present disclosure;

FIG. 2 is a schematic representation of an embodiment of the system for analysis and representation of data of FIG. 1 in accordance with an embodiment of the present disclosure;

FIG. 3 is a schematic representation of first page of a graphical user interface of the system for analysis and representation of data of FIG. 1 in accordance with an embodiment of the present disclosure;

FIG. 4 is a schematic representation of second page of the graphical user interface of the system for analysis and representation of data of FIG. 1 in accordance with an embodiment of the present disclosure;

FIG. 5 is a schematic representation of third page of the graphical user interface of the system for analysis and representation of data of FIG. 1 in accordance with an embodiment of the present disclosure;

FIG. 6 is a schematic representation of fourth page of the graphical user interface of the system for analysis and representation of data of FIG. 1 in accordance with an embodiment of the present disclosure;

FIG. 7 is a schematic representation of fifth page of the graphical user interface of the system for analysis and representation of data of FIG. 1 in accordance with an embodiment of the present disclosure;

FIG. 8 is a schematic representation of sixth page of the graphical user interface of the system for analysis and representation of data of FIG. 1 in accordance with an embodiment of the present disclosure;

FIG. 9 is an exemplary system (350) such as a computer or a server in accordance with an embodiment of the present disclosure; and

FIG. 10 is a flow chart representing the steps involved in a method for the analysis and representation of data in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for analysis and representation of data are disclosed. The system includes a memory configured to receive a plurality of data sets. The system also includes a processing subsystem operatively coupled to the memory and configured to determine a plurality of properties of the plurality of data sets. The processing subsystem is also configured to select one or more numeric variables of the plurality of data sets. The processing subsystem is further configured to analyse the one or more numeric variables of the plurality of data sets based on the plurality of properties of the plurality of data sets. The processing subsystem is further configured to identify one or more custom rules based on the plurality of data sets. The processing subsystem is further configured to derive one or more interpretations and one or more related output based on one or more identified custom rules. The processing subsystem is further configured to identify graphical representation based on outcome of the one or more identified custom rules. The processing subsystem is further configured to identify one or more textual insights based on outcome of the one or more custom rules. The processing subsystem is further configured to represent identified graphical representation and one or more textual insights on a display device.

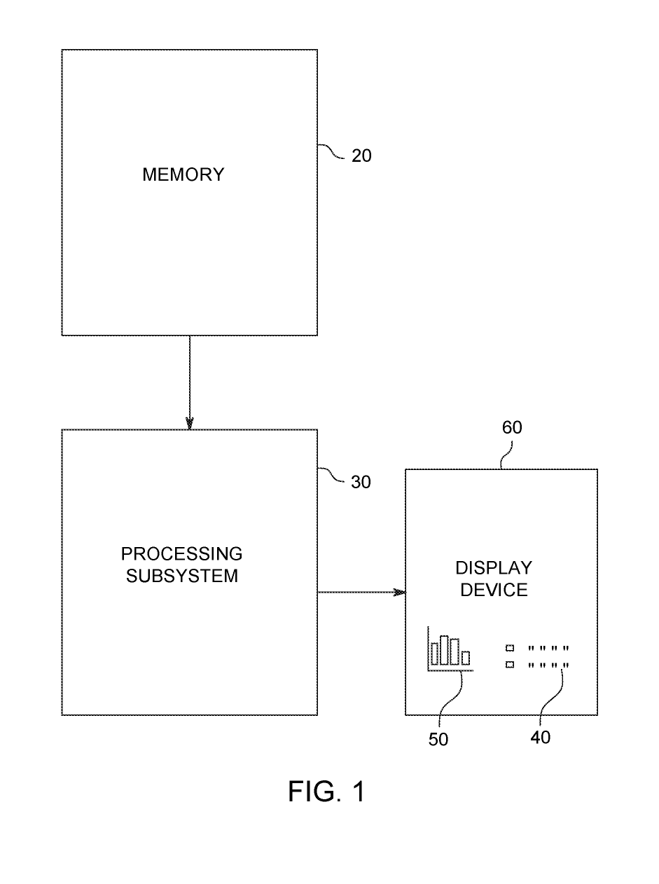

FIG. 1 is a block diagram of a system (10) for data analysis and presentation of data in accordance with an embodiment of the present disclosure. The system (10) includes a memory (20) configured to receive a plurality of data sets. In one embodiment, the plurality of data sets may be received from a plurality of sources. In such embodiment, the plurality of sources may include a web source, a local data source, an experimental data source or a manual entry of data sets in to the memory. In one embodiment, the memory (20) may include a random-access memory (RAM), a read only memory (ROM), a cache memory or a flash memory.

In some embodiments, the plurality of data sets may include a plurality of structured data, a plurality of unstructured data or a plurality of semi-structured data. The unstructured data is an information that either does not have a pre-defined data model or is not organized in a pre-defined manner. The unstructured information is typically text-heavy, but may contain data such as dates, numbers, and facts as well. The structured data refers to any data that resides in a fixed field within a record or file which includes data contained in relational databases and spreadsheets. The semi-structured data is a form of structured data that does not conform with the formal structure of data models associated with relational databases or other forms of data tables.

Also, the system (10) includes a processing subsystem (30) which is operatively coupled to the memory (20). The processing subsystem (30) is configured to determine a plurality of properties of the plurality of data sets. In one embodiment, the plurality of properties of the plurality of data sets may include an instruction set, a data type, a hierarchy of data and a category of data. The processing subsystem (30) is also configured to select one or more numeric variables of the plurality of data sets. As used herein, the numerical variable or continuous variable is one that may take on any value within a finite or infinite interval for example: height, weight, temperature, and blood glucose. In a specific embodiment, the one or more numeric variable may include float numeric variable, integer numeric variable, rational numeric variable or percentage numeric variable.

The processing subsystem (30) is further configured to analyse the one or more numeric variables of the plurality of data sets based on the plurality of properties of the plurality of data sets. The processing subsystem (30) is further configured to identify one or more custom rules based on the plurality of data sets. In one embodiment, the custom rules may include one or more statistical tests and one or more data models. As used herein, the statistical tests are where two statistical data sets are compared, or a data set is obtained by sampling and is compared against a synthetic data set from an idealised model to obtain a statistical inference. Further, the data model is an abstract model that organizes elements of data and standardizes how they relate to one another and to properties of the real-world entities.

The processing subsystem (30) is further configured to derive one or more interpretations and one or more related output based on one or more identified custom rules. The processing subsystem (30) is further configured to identify graphical representation (50) based on outcome of the one or more identified custom rules. Further, the processing subsystem (30) is configured to identify one or more textual insights (40) based on outcome of the one or more custom rules. As used herein textual insights is an understanding of a specific cause and effect within a specific context represented textually. In a specific embodiment, the textual representation of the insights may be in a natural language. In one embodiment, the one or more numeric variables are analysed to generate a graphical representation (50) from the plurality of data sets. In another embodiment, the one or more numeric variables are analysed to generate one or more insights (40) from the plurality of data sets.

Furthermore, the processing subsystem (30) is further configured to represent identified graphical representation (50) and one or more textual insights (40) on a display device (60). In such embodiment, the display device (60) may be a display device (60) of a computer, a graphical user interface or a display of any hand-held device. In one embodiment, the display device (60) may display the graphical representation (50) and the one or more textual insights (40) together on a single display. In another embodiment, the graphical representation (50) and the one or more textual insights (40) may be displayed individually which may be selected by a user viewing the presentation of the data.

In one embodiment, the graphical representation (50) may include representation of the graph as a bar graph, a line graph, a venn diagram, a histogram, a scatter plot chart, a candlestick chart, a pie chart or an area chart.

In one embodiment, the processing subsystem (30) may be further configured to analyse and present a distribution of the one or more numeric variables. The distribution of a variable refers to the set of all possible values of the variable and the associated frequencies or probabilities. Sometimes variables are distributed so that all outcomes are equally, or nearly equally likely. Other variables show results that “cluster” around one or more particular values. In some embodiments, the processing subsystem (30) is further configured to analyse and present an impact of other numeric variables on the one or more selected numeric variables and an impact of one or more categorical variables over the selected numeric variables. In a specific embodiment, the processing subsystem is further configured to generate a plurality of recommendation results to increase or optimize the one or more numeric variables.

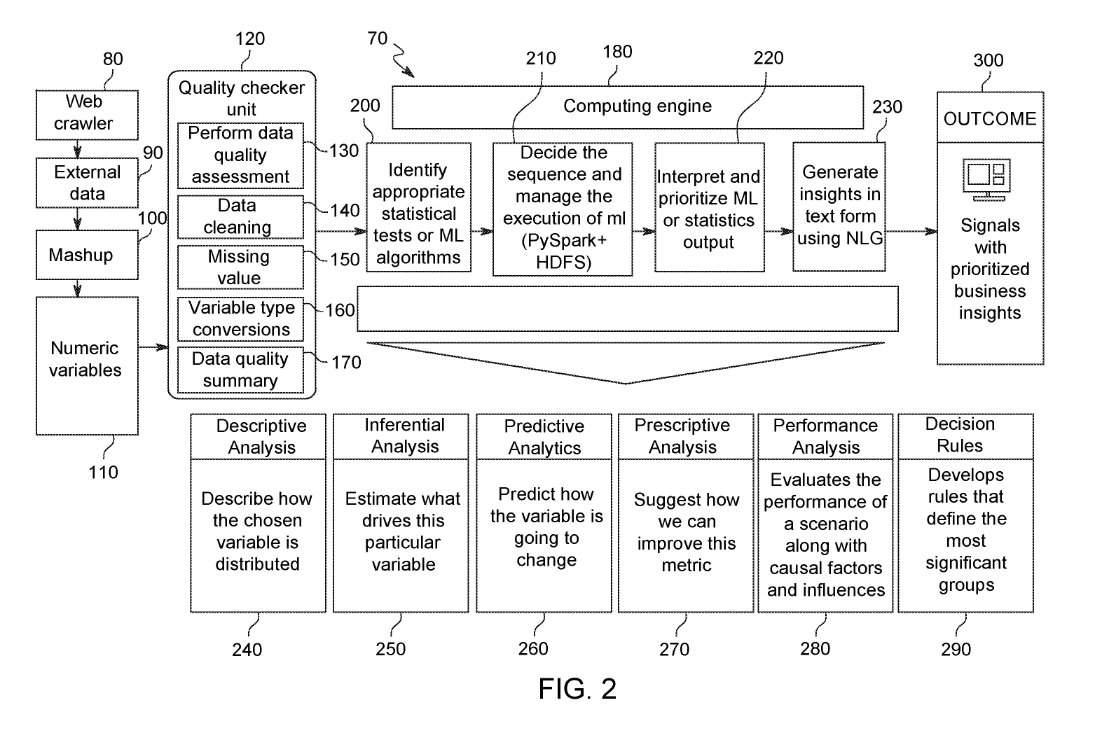

FIG. 2 is a schematic representation of an embodiment of the system for analysis and presentation of data of FIG. 1 in accordance with an embodiment of the present disclosure. The system (70) may receive a plurality of data sets by a web crawler (80). The plurality of data sets received from the web crawler (80) may be stored in a memory (20) of the system (10). Further, the plurality of data sets from the memory (20) and the plurality of data sets from an external memory (90) may be combined together using a mashup component (100).

Further, a plurality of numeric variables (110) may be selected from a plurality of combined data. The system (70) may include a quality checker unit (120) which may be configured to analyse the one or more numeric variables (110) of the combined data based on the properties of the plurality of combined data. For further analysis, the quality checker unit (120) may perform a data quality assessment (130) on the plurality of combined data to check if the system has selected a right quality of the plurality of data sets.

Further, the quality checker unit (120) may perform data cleaning (140) to correct one or more inaccuracies in the plurality of combined data sets. As used herein, the data cleaning (140) is a process of detecting, correcting or removing an inaccurate record from a record set, a table, or the database and refers to identifying an incomplete, an incorrect, an inaccurate or an irrelevant part of the data and then replacing, modifying, or deleting one or more coarse data. Further, if any incorrect or irrelevant value may be detected, the system (70) may further add or alter the incorrect or irrelevant value or may add a missing value (150) to the plurality of combined data sets. Also, the quality checker unit (120) may perform a plurality of conversions which may be based on the one or more numeric variables (110) in specific the system (70) may perform variable type conversions (160).

Further, the quality checker unit (120) may provide a summary on the quality (170) of the plurality of combined data sets. Based on the data quality summary (170) provided by the quality checker unit (120), the plurality of combined data sets may be subjected to further analysis.

Further, the system (70) includes a computation engine (180) which is configured to identify one or more textual insights and the graphical representation based on one or more analysed numeric variables and one or more custom rules. The custom rules may include one or more statistical tests or one or more data models. The computation engine (180) may select or identify one or more appropriate statistical tests or one or more machine learning model to perform the analysis of the plurality of combined data sets (190). The computation engine (180) may further decide or select a sequence for the identified one or more statistical tests or one or more machine learning model (200). The computation engine (180) may further interpret the one or more sequenced statistical tests (210). The computation engine (180) may further provide a priority to one or more interpreted statistical tests (220). Further, the computation engine (180) may identify the one or more textual insights and generate the graphical representation based on the priority of the statistical test (230).

In one embodiment, the analysis of one or more statistical data may be a descriptive analysis (240), in which the system (70) may describe how the selected plurality of data sets may be distributed. In another embodiment, the analysis of one or more statistical data may be an inferential analysis (250), in which the system (70) may estimate what plurality of parameters may drive a particular numeric variable (110). In yet another embodiment, the analysis of one or more statistical data may be a predictive analysis (260), in which the system (70) may predict or analyse for how long the one or more numeric variable (110) may change. In yet another embodiment, the analysis of one or more statistical data may be a prescriptive analysis (270), in which the system (70) may suggest the machine learning model how to improve the analysis of the plurality of data sets.

In such embodiment, the analysis of one or more statistical data may be a performance analysis (280), in which the system (70) may evaluate or analyse a performance of a scenario along with a plurality of factors influencing the one or more numeric variables (110). In such another embodiment, the analysis of one or more statistical data may be a set of decision rules (290), in which the system (70) may develop a set of rules that may define a most significant group.

Moreover, one or more identified textual insights and the generated graphs are displayed on the display device (300). The quality checker unit (120) and the computation engine (180) of the FIG. 2 is substantially similar to processing subsystem (30) of FIG. 1.

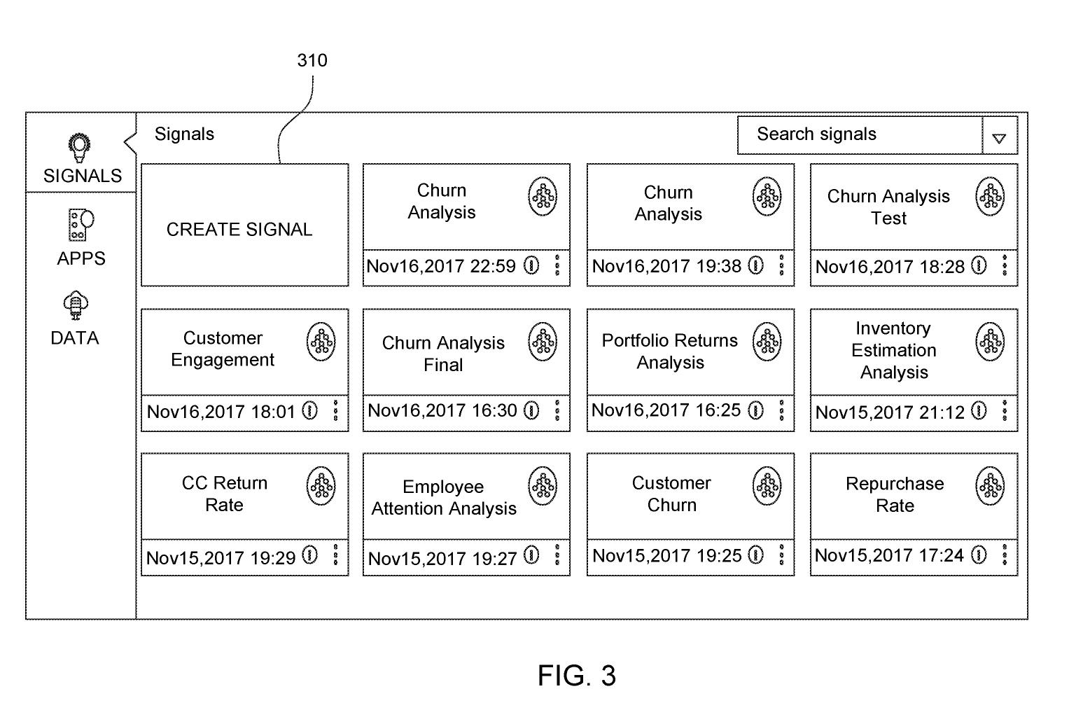

FIG. 3 is a schematic representation of first page of a graphical user interface of the system for analysis and representation of data of FIG. 1 in accordance with an embodiment of the present disclosure. The system (40) is an example for analysis and representation of call centre data. The first page of the graphical user interface of the system represents various projects to create an analysis for a set of data. A user needs to select the create signal option (310) displayed on the graphical user interface to initiate the analysis.

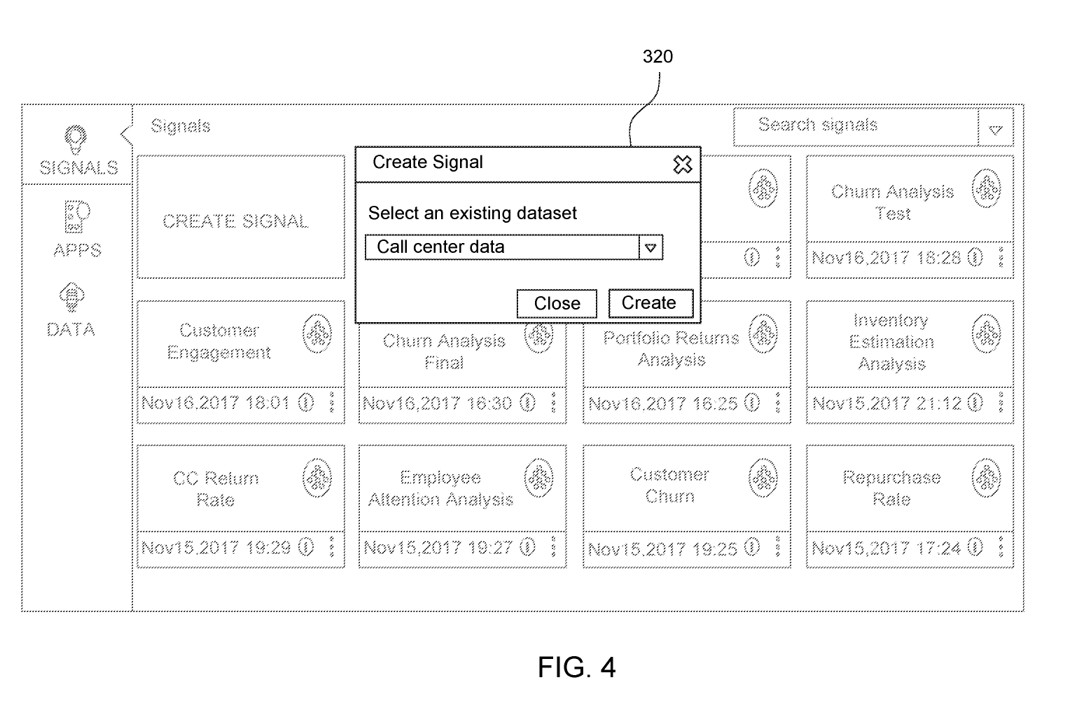

FIG. 4 is a schematic representation of second page of the graphical user interface of the system for analysis and representation of data of FIG. 1 in accordance with an embodiment of the present disclosure. The second page of the graphical representation of the system represents an option to select the existing data set (320). The user needs to select the call centre data from the existing data set.

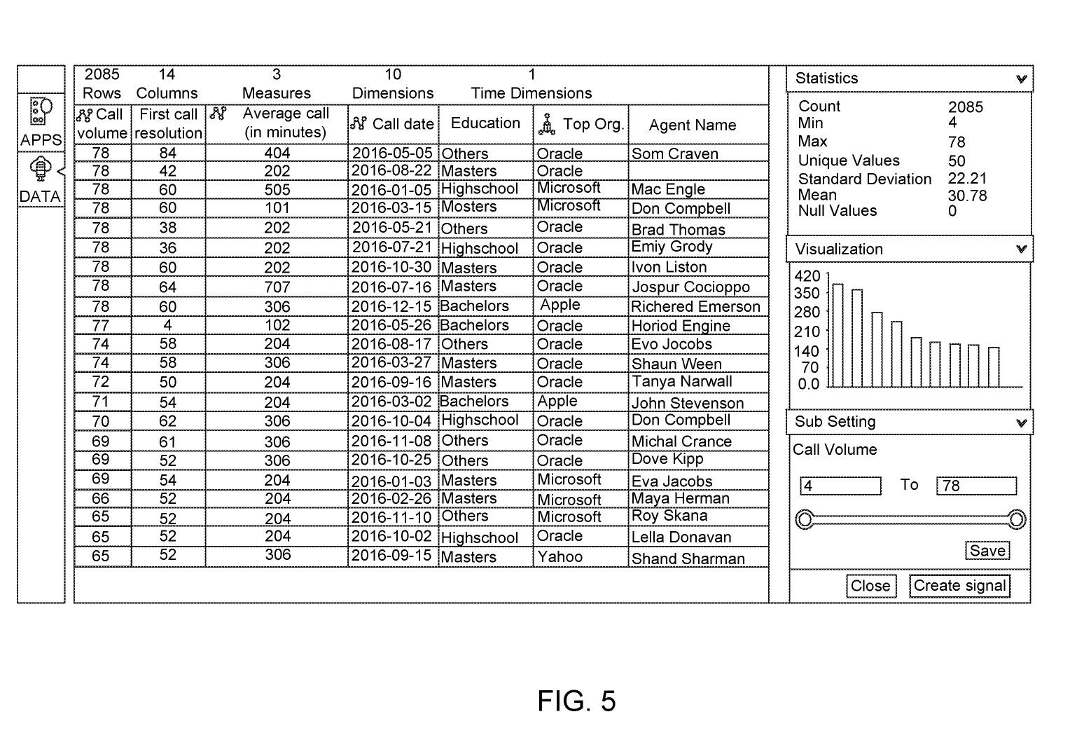

FIG. 5 is a schematic representation of third page of the graphical user interface of the system for analysis and representation of data of FIG. 1 in accordance with an embodiment of the present disclosure. The graphical user interface represents the plurality of internal data and the plurality of external data in the form of rows and columns. The graphical user interface represents may also display a statistical data of a plurality of parameters. In such embodiment, the plurality of parameters may be a count, a minimum value, a maximum value, a unique value, a standard deviation value, a mean and a null value. The system (10) may also display a visualization of the plurality of data sets in the form of a graph. The graphical user interface represents may also display a sub setting slab which may allow the user to select a required range of call volume. Once the user sets the required parameters, the user may select create signal for analysing the call data according to the selected parameters.

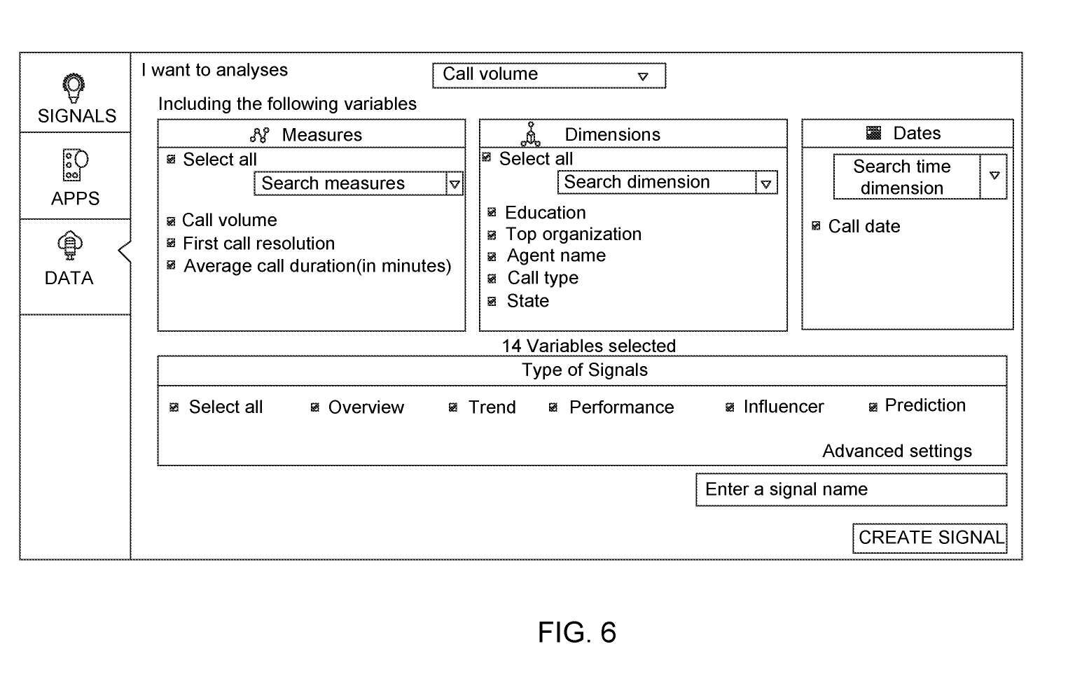

FIG. 6 is a schematic representation of fourth page of the graphical user interface of the system for analysis and representation of data of FIG. 1 in accordance with an embodiment of the present disclosure. The graphical user interface represents may display the one or more numeric variables such as the measure, the dimension and the dates. The user may now select the one or more numeric variables of desired choice. Based on the selection of the one or more numeric variable, the system may perform the analysis. The selected one or more numeric variable under the measures may be a call volume, a first call resolution and average call duration. The selected plurality of the one or more numeric variables under the dimensions may include education, a top organisation, an agent name, a call type or a state. The user may select multiple dimensions, or all the dimensions displayed. The selected plurality of numeric variable under the dates may include a call date. Further, once the user selects the one or more numeric variable of his choice and select create signal, the system may further proceed with the analysis of the call data.

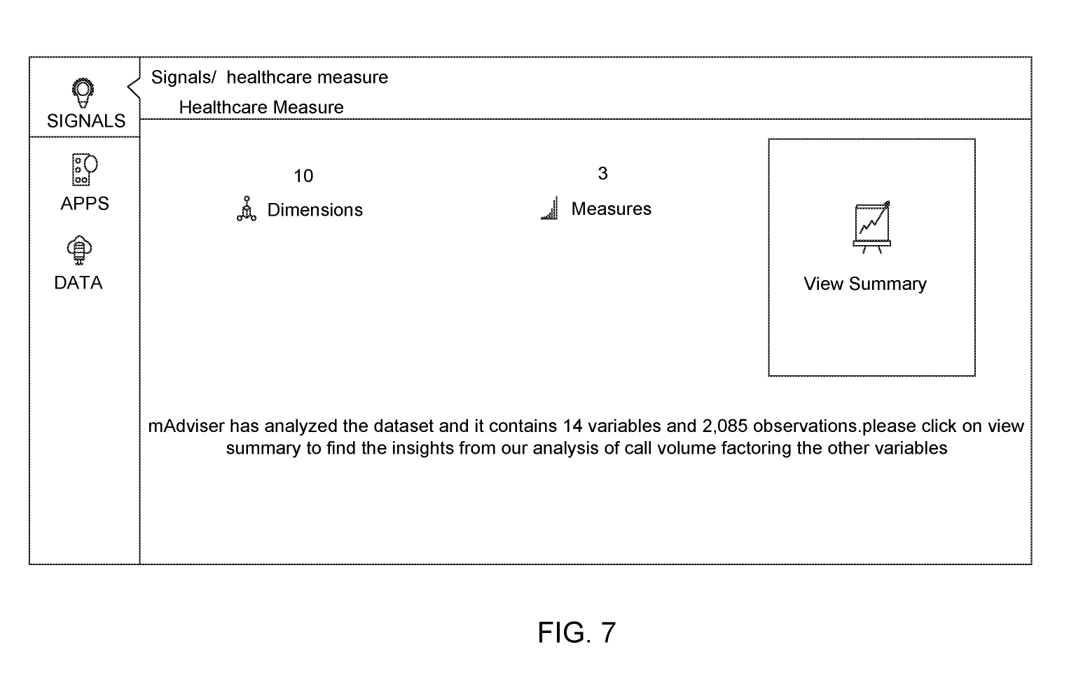

FIG. 7 is a schematic representation of fifth page of the graphical user interface of the system for analysis and representation of data of FIG. 1 in accordance with an embodiment of the present disclosure. The system displays the number of selected plurality of parameters and may provide an option to view a summary of the selected plurality of parameters. As shown, the system displays dimensions which may be the selected dimensions by the user. The system may also display 3 measures, which may be the selected measures by the user. The user may now select view summary to view the presentation of the analysed plurality of data sets and the textual insights created based on the analysed graph.

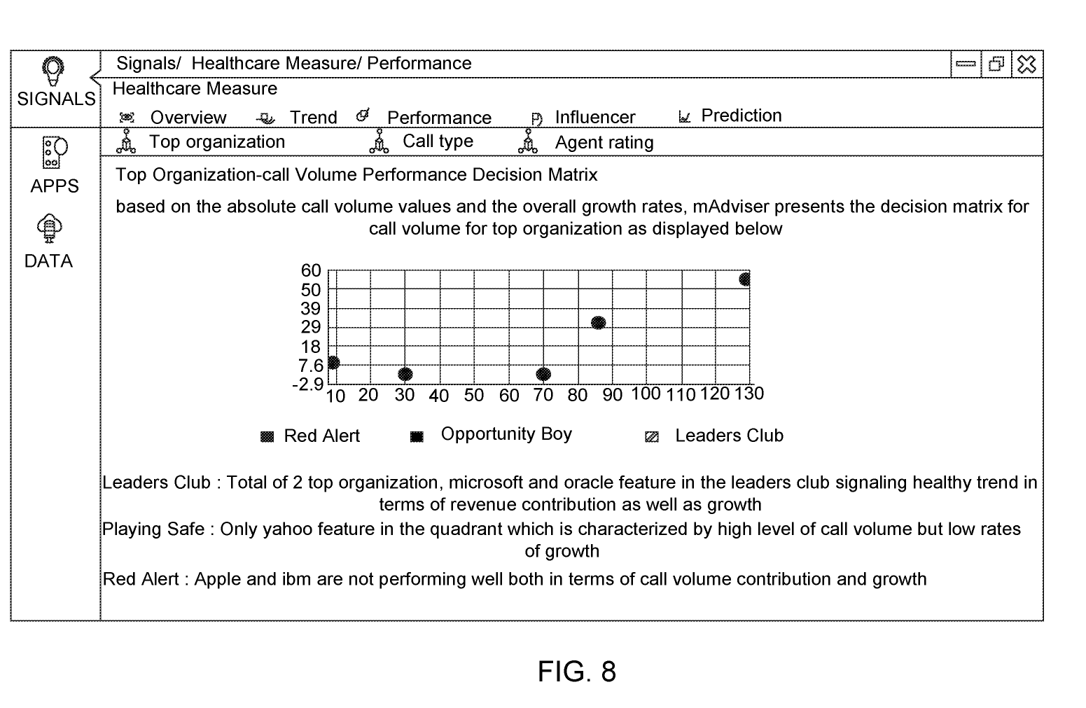

FIG. 8 is a schematic representation of sixth page of the graphical user interface of the system for analysis and representation of data of FIG. 1 in accordance with an embodiment of the present disclosure. The system (10) may represent a plurality of combinations of the selected plurality of parameters and the plurality of data sets. In one case, the system may display a graph and the textual insight for the selected plurality of parameters such as the top organisation and call volume. In such case, the graphical representation generates the one or more textual insights as that the call volume observations are spread across many categories and the distribution is positively skewed which implies that there is a significant chunk of low value call volume observations.

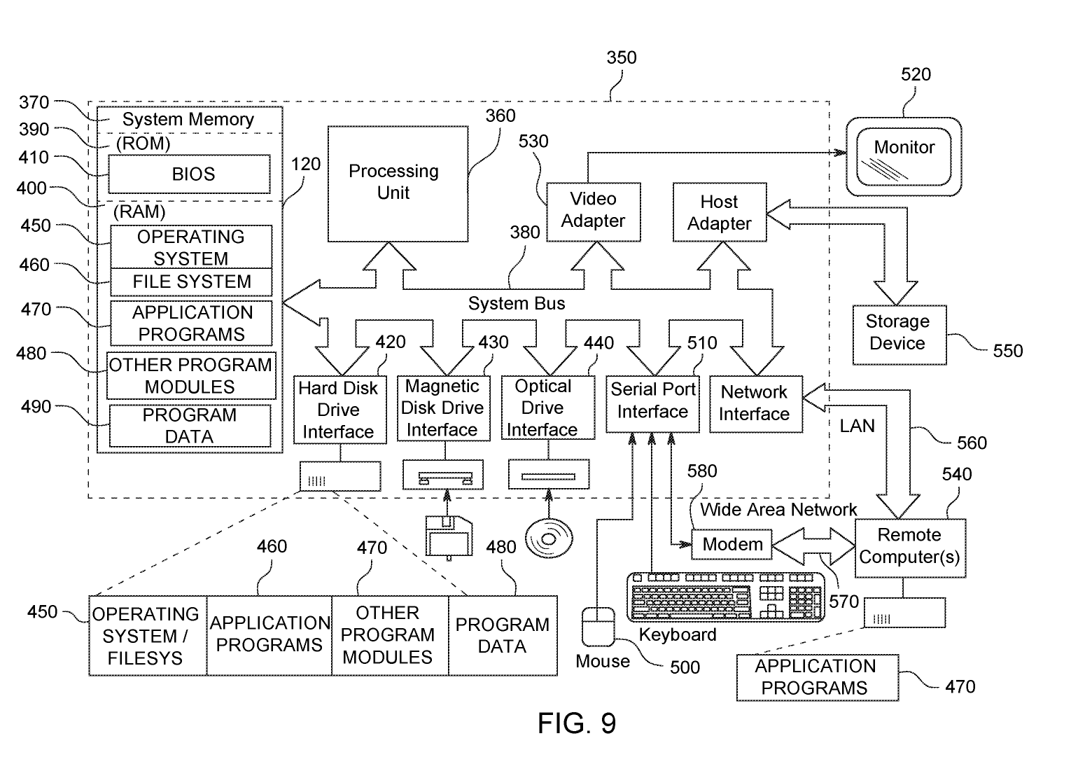

FIG. 9 is an exemplary system (350) such as a computer or a server in accordance with an embodiment of the present disclosure. The exemplary system (350) for analysis and representation of data includes a general-purpose computing device in the form of a computer (350) or a server or the like. The computer (350) includes including a processing unit (360) substantially similar to the processing subsystem (30) of FIG. 1, and configured to analyse and present the plurality of data sets in at least one form. The computer also includes a system memory (370) substantially similar to the memory (20) of FIG. 1, and configured to store the plurality of internal data sets and the plurality of external data sets. The computer (350) also includes a system bus (380) that couples various system components including the system memory (370) to the processing unit (360).

The system bus (380) may be any of several types of bus structures including a memory bus or memory controller, a peripheral bus, and a local bus using any of a variety of bus architectures. The system memory (370) includes read-only memory (ROM) (390) and random access memory (RAM) (400). A basic input/output system (BIOS) (410), containing the basic routines that help transfer information between elements within the computer (350), such as during start-up, is stored in ROM (390).

The computer (350) may further include a hard disk drive for reading from and writing to a hard disk, not shown, a magnetic disk drive for reading from or writing to a removable magnetic disk, and an optical disk drive for reading from or writing to a removable optical disk such as a CD-ROM, DVD-ROM or other optical media.

The hard disk drive, magnetic disk drive, and optical disk drive30 are connected to the system bus by a hard disk drive interface (420), a magnetic disk drive interface (430), and an optical drive interface (440), respectively. The drives and their associated computer-readable media provide non-volatile storage of computer readable instructions, data structures, program modules and other data for the computer (350) to the various results generated from the data processing unit (360).

Although the exemplary environment described herein employs a hard disk, a removable magnetic disk and a removable optical disk, it should be appreciated by those skilled in the art that other types of computer readable median that can store data that is accessible by a computer, Such as magnetic cassettes, flash memory cards, digital video disks, Bernoulli cartridges, random access memories (RAMS), read-only memories (ROMs) and the like may also be used in the exemplary operating environment.

A number of program modules may be stored on the hard disk, magnetic disk, optical disk, ROM (390) or RAM (400), including an operating system (450). The computer (350) includes a file system (460) associated with or included within the operating system (450), one or more application programs (470), other program modules (480) and program data (490). A user may enter commands and information into the computer (350) through input devices (500) such as a keyboard and pointing device. Other input devices (not shown) may include a microphone, joystick, game pad, Satellite dish, Scanner or the like.

These and other input devices are often connected to the data processing unit (360) through a serial port interface (510) that is coupled to the system bus, but may be connected by other interfaces, such as a parallel port, game port or universal serial bus (USB). A monitor (520) or other type of display device is also connected to the system bus (380) via an interface. Such as a video adapter (530). In addition to the monitor (520), personal computers typically include other peripheral output devices (not shown), such as speakers and printers.

The computer (350) may operate in a networked environment using logical connections to one or more remote computers (540). The one or more remote computer (540) may be another computer, a server, a router, a network PC, a peer device or other common network node, and typically includes many or all of the elements described above relative to the computer (350), although only a memory storage device (550) has been illustrated. The logical connections include a local area network (LAN) (560) and a wide area network (WAN) (570). Such networking environments are common place in offices, enterprise-wide computer networks, Intranets and the Internet.

When used in a LAN (560) networking environment, the computer (350) is connected to the local network (560) through a network interface or adapter (370). When used in a WAN (570) networking environment, the computer (350) typically includes a modem (580) or other means for establishing communications over the wide area network (570), such as the Internet.

The modem (580), which may be internal or external, is connected to the system bus (380) via the serial port interface (510). In a networked environment, program modules depicted relative to the computer (350), or portions thereof, may be stored in the remote memory storage device. It will be appreciated that the network connections shown are exemplary and other means of establishing a communications link between the computers may be used.

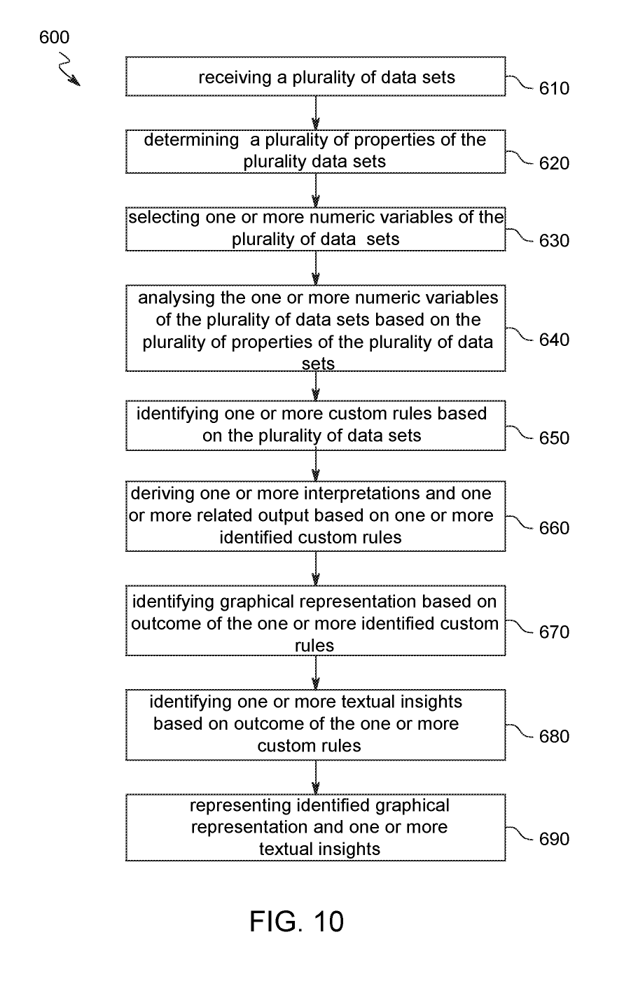

FIG. 10 is a process flow for the data analysis and presentation of data in accordance with the embodiment of the present disclosure. The method (600) includes receiving a plurality of data sets in step (610). In one embodiment, receiving the plurality of data set may include receiving the plurality of data from a plurality of means such as a web, a manual entry of data, a local data and an experimental data.

The method (600) also includes determining a plurality of properties of the plurality of data sets in step 620. In one embodiment, the plurality of properties may be the instruction set, the data type, the hierarchy of data and the category of data.

The method (600) further includes selecting one or more numeric variables of the plurality of data sets in step 630. In one embodiment, the plurality of data sets may be a plurality of structured data, a plurality of unstructured data or a plurality of semi-structured data.

The method (600) further includes analysing the one or more numeric variables of the plurality of data sets based on the plurality of properties of the plurality of data sets in step 640. The method (600) further includes identifying one or more custom rules based on the plurality of data sets in step 650. The method (600) further includes deriving one or more interpretations and one or more related output based on one or more identified custom rules in step 660. The method (600) further includes identifying graphical representation based on outcome of the one or more identified custom rules in step 670.

In a specific embodiment, identifying graphical representation based on outcome of the one or more identified custom rules may include identifying one or more statistical tests from the one or more custom rules. In such embodiment, identifying one or more statistical tests from the one or more custom rules may include deciding a sequence of execution of the one or more statistical tests. In some embodiments, identifying one or more statistical tests from the one or more custom rules may include interpreting and prioritising the one or more statistical tests. In one embodiment, identifying graphical representation based on a priority of one or more statistical tests.

In a specific embodiment, identifying the one or more statistical tests may include identifying the one or more statistical tests based on use case, feature transformation, feature selection and optimization based on the data sizes. The method (600) further includes identifying one or more textual insights based on outcome of the one or more custom rules in step 680. The method (600) further includes representing identified graphical representation and one or more textual insights in step 690. In one embodiment, presenting the one or more textual insights (506) may include presenting one or more textual insights in a natural language.

Various embodiments of the system described above enables the automatic analysis of data and presentation of the analysed data graphically and also in the form of textual insights.

Also, the system has the ability to comprehend and monetize the plurality of data sets of huge size. The system identifies one or more textual insights and generate a graphical representation. Hence, the system is very fast and saves time which makes the system effective.

Further the system has no dependency on a data scientists and analysts to create brief about the plurality of data sets to be analysed. Also, the system is expandable and scalable to adoption of new cases.

Further, the system produces insights which are specific to the analysis performed and are easily readable and understandable by the user, which makes the user to spend less time in further analysing the textual insights. The system also predicts the plurality of data sets to be analysed and hence does not miss out on any data set.

In addition, the system may help the user to determine some of the most common characteristic of key values under the target categorical variable. Further, the system also leverages prescriptive analytics approach on the dataset, to analyse potential decisions, interactions between decisions and influences on possible outcomes, to prescribe an optimal decision of action.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for data analysis and presentation of data comprising:
a memory configured to receive a plurality of data sets;
a processing subsystem operatively coupled to the memory and configured to:
determine a plurality of properties of the plurality of data sets;
select one or more numeric variables of the plurality of data sets;
analyse the one or more numeric variables of the plurality of data sets based on the plurality of properties of the plurality of data sets;
identify one or more custom rules based on the plurality of data sets;
derive one or more interpretations and one or more related output based on one or more identified custom rules;
identify graphical representation based on outcome of the one or more identified custom rules;
identify one or more textual insights based on outcome of the one or more custom rules; and
represent identified graphical representation and one or more textual insights on a display device.

2. The system as claimed in claim 1, wherein the plurality of data sets comprises a plurality of structured data, a plurality of unstructured data or a plurality of semi-structured data.

3. The system as claimed in claim 1, wherein the plurality of properties of the plurality of data sets comprises an instruction set, a data type, a hierarchy of data and a category of data.

4. The system as claimed in claim 1, wherein the one or more custom rules comprises one or more statistical tests and one or more data models.

5. The system as claimed in claim 1, wherein the processing subsystem is further configured to analyse and present a distribution of the one or more numeric variables.

6. The system as claimed in claim 1, wherein the processing subsystem is further configured to analyse and present an impact of other numeric variables on the one or more selected numeric variables and an impact of one or more categorical variables over the selected numeric variables.

7. The system as claimed in claim 1, wherein the processing subsystem is configured to generate a plurality of recommendation results to increase or optimize the one or more numeric variables.

8. A method for data analysis and presentation of data comprising:
receiving a plurality of data sets;
determining a plurality of properties of the plurality of data sets;
selecting one or more numeric variables of the plurality of data sets;
analysing the one or more numeric variables of the plurality of data sets based on the plurality of properties of the plurality of data sets;
identifying one or more custom rules based on the plurality of data sets;
deriving one or more interpretations and one or more related output based on one or more identified custom rules;
identifying graphical representation based on outcome of the one or more identified custom rules;
identifying one or more textual insights based on outcome of the one or more custom rules; and
representing identified graphical representation and one or more textual insights.

9. The method as claimed in claim 6, wherein identifying graphical representation based on outcome of the one or more identified custom rules comprises:
identifying one or more statistical tests from the one or more custom rules;
deciding a sequence of execution of the one or more statistical tests;
prioritising the one or more statistical tests; and
identifying graphical representation based on a priority of one or more statistical tests.

10. The method as claimed in claim 6, wherein representing the one or more textual insights comprises representing one or more textual insights in a natural language.
